(19) United States
(12) Patent Application Publication
(10) Pub. No.: US 2021/0024195 A1
(43) Pub. Date: Jan. 28, 2021

(54) CONTRACTED BOND ASSEMBLIES, SYSTEMS AND METHODS FOR SAME

(71) Applicants: Bradley Roger Jensen, Beresford, SD (US); Nicholas Young, Des Moines, IA (US)

(72) Inventors: Bradley Roger Jensen, Beresford, SD (US); Nicholas Young, Des Moines, IA (US)

(21) Appl. No.: 16/937,290

(22) Filed: Jul. 23, 2020

Related U.S. Application Data
(60) Provisional application No. 62/877,703, filed on Jul. 23, 2019.

(51) Int. Cl. B64B 1/40; B32B 37/06

(52) U.S. Cl. CPC B64B 1/40; G01W 1/08; B32B 37/06

(57) ABSTRACT

A polymer film assembly includes a stack of two or more polymer films. At least one of the polymer films includes directionally oriented molecules. The stack includes a first polymer film and a second polymer film layered with the first polymer film. A contracted bond assembly couples the first and second polymer films of the stack. The contracted bond assembly includes heated and contracted configurations. In the heated configuration the contracted bond assembly includes a bond fusion zone and a film interface having directionally disoriented molecules and an interface width between the bond fusion zone and the remainder of the first and second polymer films. In the contracted configuration the film interface is a contracted film interface having a contracted interface width less than the interface width and a contracted thickness greater than one or more of film thicknesses of the first or second polymer films.

### RELATED APPLICATIONS

This application claims the benefit of priority to U.S. Patent Application Ser. No. 62/877,703, filed Jul. 23, 2019, which application is incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries, Inc. of Sioux Falls, S. Dak. All Rights Reserved.

### TECHNICAL FIELD

This document pertains generally, but not by way of limitation, to bonding of polymer films in atmospheric balloons, aerostats and inflatable articles.

### BACKGROUND

Atmospheric balloons, aerostats and inflatable articles are constructed with a 25 plurality of pliable sheets coupled along respective edges. In one example, the pliable sheets for an atmospheric balloon, such as gores, are bonded together with heat sealing of the gores, for instance with a band sealer or impulse sealer. In an example including the band sealer the gores are stacked and fed between opposed rotating bands engaged at a nip interface to clamp the stacked edges together. The 30 band at the nip interface is heated with one or more heating bars engaged with an interior surface of the bands. The heated nip interface increases the temperature of the polymer gores and facilitates bonding. The bonded gores continue through the band sealer, and while the gores are clamped with the nip interface, the bands are cooled with one or more cooling blocks thereby cooling and setting the bond and minimizing adhesion to the bands. As the bands continue to rotate the gores and cooled bond are moved through the band sealer, and the cooled bond is released as the nip interface draws apart with further rotation of the bands.

In another example, an impulse sealer receives the stacked gores and, like the band sealer, clamps the stacked gores together between opposed heated plates. The heated plates bond the gores. The resulting bond for the gores remains clamped while the heated plates are cooled (e.g., with a refrigerant system) to set the bond and minimize adhesion of the gore material to the plates. The plates are decoupled thereby releasing the clamping of the bonded gores, and the gores are advanced relative to the impulse sealer. The process is repeated for the next portion of the gores.

### SUMMARY

The present inventors have recognized, among other things, that a problem to be solved includes minimizing weaknesses in polymer sheets when heat bonding the sheets. Materials including oriented molecules provide enhanced strength to pliable sheets, such as gores, used in atmospheric balloons and aerostats. The oriented molecules provide improved tensile strength (relative to a non-oriented version of the same material) at least along the axis of orientation. Examples of materials including oriented molecules include, but are not limited to, thermoplastic polymers having oriented molecules, axially oriented polyethylene, a partially cross-linked oriented polyethylene, such as bi-axially oriented polyethylene film (BOPE) or the like. The enhanced strength of oriented polymers allows for the use of low weight polymers (e.g., with decreased thickness) thereby decreasing the weight of the balloon assembly increasing the potential payload. One example of BOPE has a tensile strength of between around 15,000 to 20,000 psi.

In an example atmospheric balloon, aerostat or inflatable article (herein balloon) including oriented molecule polymer gores the gores are stacked and clamped between one of rotating bands of a band sealer or plates of an impulse sealer to generate a bond assembly including the bond fusion zone and adjacent heated portions of the gores (herein adjacent gore portions). The gores are heated to initiate a bond and then cooled while clamped to set the bond at the bond fusion zone. The heating of the oriented molecule polymer disrupts the orientation of the molecules and accordingly decreases the tensile strength of the polymer. In one example, the bond fusion zone includes multiple layers between the adjacent gores and is relatively strong because of the multiple layers despite the loss of molecular orientation. However, the polymer of the film interfaces proximate to the bond fusion zone (e.g., the adjacent heated portions of the gores) also loses molecular orientation because of heating of the bond fusion zone. The adjacent heated portions thereby have decreased strength (e.g., tensile strength, strength transverse to an axis of the bond or the like). In some loading examples the weakened film interfaces (the adjacent heated portions) burst between the bond fusion zone and the remainder of the (still molecularly oriented) polymer films.

The present subject matter can help provide a solution to this problem, such as by a contracted bond assembly that couples two or more polymer films with a bond fusion zone and contracted film interfaces (in contrast to the adjacent heated portions described herein) interposed between the bond fusion zone and the remainder of the polymer films. The films are bonded with heated and contracted configurations. In the heated configuration the films are heated and pressed together at a bond fusion zone. Film interfaces are provided along the bond fusion zone from the polymer films and include directionally disoriented molecules because of heating at the bond fusion zone.

In the contracted configuration, the film interface is contracted (e.g., to a contracted film interface) to a contracted interface width less than an interface width of the film interface in the heated configuration. The thickness of the film interface increases (as the film interfaces contract along the width) because of the contraction and is greater than a stack thickness of the component films. In one example, the direction of the thickness increase is transverse to the plane of the polymer films. In another example, the contracted thickness of the contracted film interface is proximate to a bond thickness of the bond fusion zone (also greater than the stack thickness). The increased thickness of the contracted film interface enhances the strength of the contracted film interface and accordingly minimizes failure of the contracted bond assembly at the interfaces (such as the previously discussed adjacent heated portions). Additionally, the contraction promotes bonding of the component film interfaces of each of the component films. For instance, as the film interface contracts separated first and second films of the film interface are drawn into intimate contact and bond thereby further enhancing the strength of the contracted film interface.

During contraction the contracted bond assembly is tensioned, for instance by pulling of the films between opposed anchors, drawing of the films away from a system outlet of a band sealer or the like. The tension (e.g., along a tensile axis) along the bond fusion zone promotes contraction of the film interfaces (decrease in width) to form the contracted film interfaces having increased thickness. To facilitate contraction, thickening and bonding of the film interfaces, in one example the compressive force applied to the bond fusion zone is relaxed after initial bonding (decreased relative to the heated configuration) and the tolerance is increased (the space between the opposed plates, bands or the like) to promote contraction into the zone provided by the larger space. As contraction proceeds the contracted bond assembly engages with an opposed surface or surfaces (e.g., of band sealer plates or the like), and the opposed surfaces accordingly shape the bond assembly to have a corresponding bond profile, such as a planar bond profile.

The contracted bond assembly has enhanced strength relative to bonds including film interfaces with directionally disoriented molecules. The increased thickness of the contracted film interfaces along with the bond fusion zone have strengths (transverse contracted strength and transverse bond strength, respectively, relative to the longitudinal bond axis) proximate to the strength (e.g., tensile strength) of the parent material of the component films. In some examples, for instance with biaxial stress applied along the longitudinal bond axis and transverse to the bond axis (e.g., while an article is inflated and the gores and bond experience biaxial stress) the contracted bond assembly includes biaxial contracted strength (of the contracted film interface) and biaxial bond strength (of the bond fusion zone) equal to or greater than the biaxial strengths of the parent materials of the component films

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of one example of an atmospheric balloon.

FIG. 2 is a detailed perspective view of the atmospheric balloon of FIG. 1.

FIG. 3A is a first schematic view of one example of a bonding system.

FIG. 3B is a second schematic view of the bonding system of FIG. 3A.

FIG. 4A is a cross sectional view of example gore films.

FIG. 4B is a cross sectional view of the gore films of FIG. 4A engaged between heating elements.

FIG. 4C is a cross sectional view of the gore films of FIG. 4B engaged between cooling elements.

FIG. 4D is a cross sectional view of one example of a completed bond assembly.

FIG. 5A is a cross sectional view of another example of gore films.

FIG. 5B is a cross sectional view of the gore films of FIG. 5A engaged between heating elements.

FIG. 5C is a cross sectional view of a contracted bond assembly passively engaged between cooling elements 308.

FIG. 5D is a cross sectional view of the contracted bond assembly of FIG. 5C having contracted film interfaces.

FIG. 5E is a perspective sectional view of the contracted bond assembly of FIG. 5D.

FIG. 6 is a block diagram showing one example of a method for bonding films.

### DETAILED DESCRIPTION

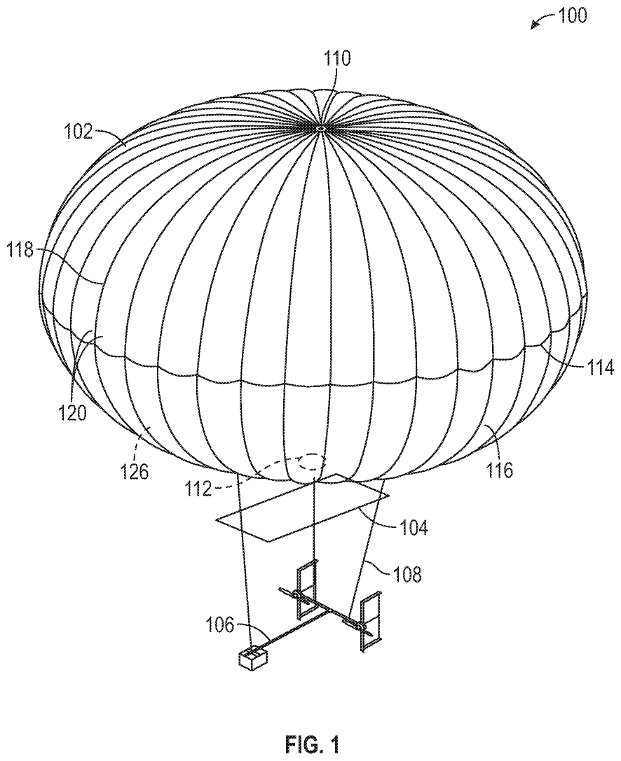

FIG. 1 shows one example of an inflatable article, such as an atmospheric (e.g., stratospheric) balloon system 100. The atmospheric balloon system 100 includes, but is not limited to weather balloon type systems, airships, dirigibles, aerostats or the like (collectively balloon systems). As shown the atmospheric balloon system 100 includes a balloon 102 (e.g., a pumpkin balloon, lobed balloon, aerodynamic inflated body or the like, collectively referred to as balloons) coupled with a payload 104 and an optional propulsion system 106, for instance by one or more suspension lines 108. In the example shown in FIG. 1 the balloon 102 is formed between an upper apex 110 and a lower apex 112. For instance, the balloon 102 includes a plurality of panels, such as gores, coupled along corresponding gore edges 120. As described herein, the gores are coupled with contracted bond assemblies 118 having strength (e.g., tensile strength, bi-axial strengths per unit of axial length or the like) that approach the corresponding strength of the base material of the gores, such as polyethylene having directionally oriented molecules, for instance with a tensile strength of between around 15,000 to 20,000 psi. In another example, the balloon 102 includes an upper balloon panel 114 extending from the upper apex 110 to the balloon equator 114. A lower balloon panel 116 extends from the lower apex 112 to the balloon equator 114. The upper and lower balloon panels 114, 116 are coupled with the contracted bond assemblies 118 described herein.

Referring again to FIG. 1, the payload 104 is shown suspended beneath the balloon 102 on one or more suspension lines 108. In one example the payload 104 includes one or more of instruments, communication devices and the like configured to provide additional functionality to the atmospheric balloon system 100. In one example, the atmospheric balloon system 100 with the payload 104 is configured to provide observation beneath and around the balloon system 100 as well as one or more communication features (e.g., transmission of information, reception of information or the like). In another example, the payload 104 comprises a framework suspended beneath the atmospheric balloon system 100 including for instance an air ballast blower configured to provide atmospheric air to a ballonet within the balloon 102, a source of lighter-than-air gas configured to provide lighter-than-air gas (e.g., a lift gas such as helium or hydrogen) to a lift gas chamber of the balloon 102 or the like. In another example the payload 104 includes a controller configured to control the relative volume of each of the ballonet and the lift gas chamber to control the buoyancy of the atmospheric balloon assembly 100 (e.g., to maintain neutral buoyancy, provide positive or negative buoyancy or the like).

As further shown in FIG. 1, an optional propulsion system 106 is coupled with the atmospheric balloon system 100. In one example the propulsion system 106 provides one or more sources of propulsion for instance propellers, guidance fins or the like as well as a power source (e.g., battery array, solar panels or the like) configured to operate the propulsion system, such as one or more propellers. In one example the propulsion system 106 includes two or more propellers spaced from each other. The two or more propellers are thereby able to provide counteracting or cooperative torques or coordinated propulsion to the atmospheric balloon system 100 to rotate the dual chamber balloon 102 and reorient the propulsion system 106 and provide directional control and propulsion to the atmospheric balloon system 100.

Referring again to the view shown in FIG. 1, the balloon 102 of the balloon system 100 (or other inflatable article including an airship, dirigible, aerostat or the like, collectively balloon systems) as previously described is formed with one or more panels such as gores 116, panels or the like coupled to form a balloon assembly (or balloon 102). Optionally, the gores 116 have triangular profiles that extend from one of the upper or lower apex 110, 112 to the balloon equator 114 and are bonded along the gore edges 120. In another example, the gores 116 have diamond profiles that extend between the upper and lower apexes 110, 112. The gores 116, are coupled along gore edges 120 with fusion of the gore edges 120 to form a bond. As described herein the bond assemblies 118 are contracted to provide enhanced strength relative to other bonds and minimize failure of the balloon 102 proximate to the bond assemblies 118, for instance because of disorienting of otherwise directionally oriented molecules.

FIG. 2 is a detailed perspective view of the balloon 102 (e.g., including the body of an atmospheric balloon, aerostat, airship, dirigible or the like, collectively balloons). The balloon 102 in this example includes a plurality of balloon gores 116 each having respective gore edges 120. The gore edges 120 are coupled with proximate gore edges 120 of other balloon gores 116 with contracted bond assemblies 118. The gore edges 120 are heated and pressed together, for instance along a heated nip, to bond the balloon gores 116. In one example, material of the balloon gores 116 includes a polymer having directionally oriented molecules to enhance the strength of the gores 116. Examples of materials including oriented molecules include, but are not limited to, thermoplastic polymers having oriented molecules, axially oriented polyethylene, a partially cross-linked oriented polyethylene, such as bi-axially oriented polyethylene film (BOPE) or the like.

As described herein, the heating of the balloon gores 116 disorients the molecules and accordingly decreases the strength of the bond assembly. For example, the material of the balloon gores 116 proximate to the bond itself (e.g., an interface between the bond and the remainder of the balloon gore material) includes disoriented molecules and is weakened relative to the remainder of the balloon gore having directionally oriented molecules and the bond itself having fused and thereby thicker and stronger plies of the material with disoriented molecules. The contracted bond assemblies 118 described herein enhance the strength of the assembly including the gore material proximate to the bond including disoriented molecules.

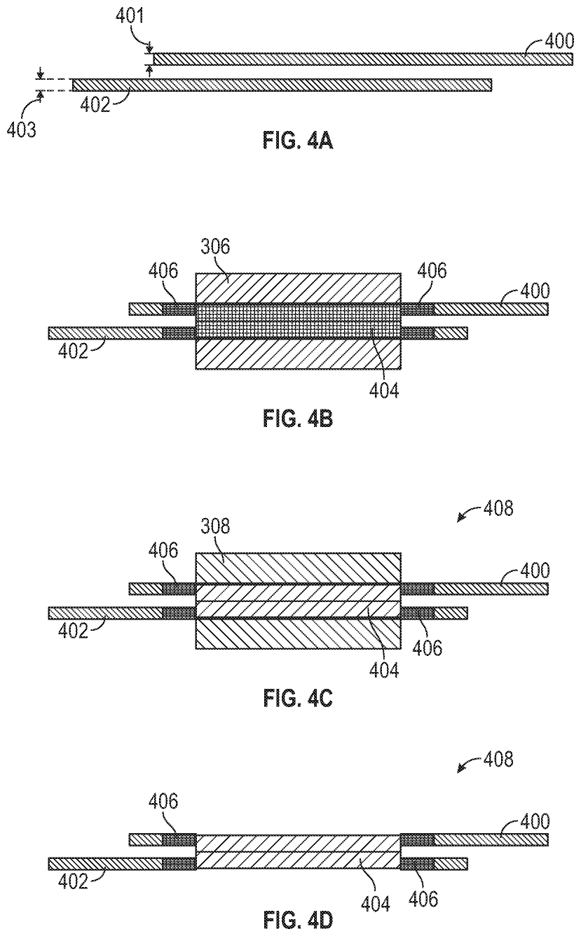

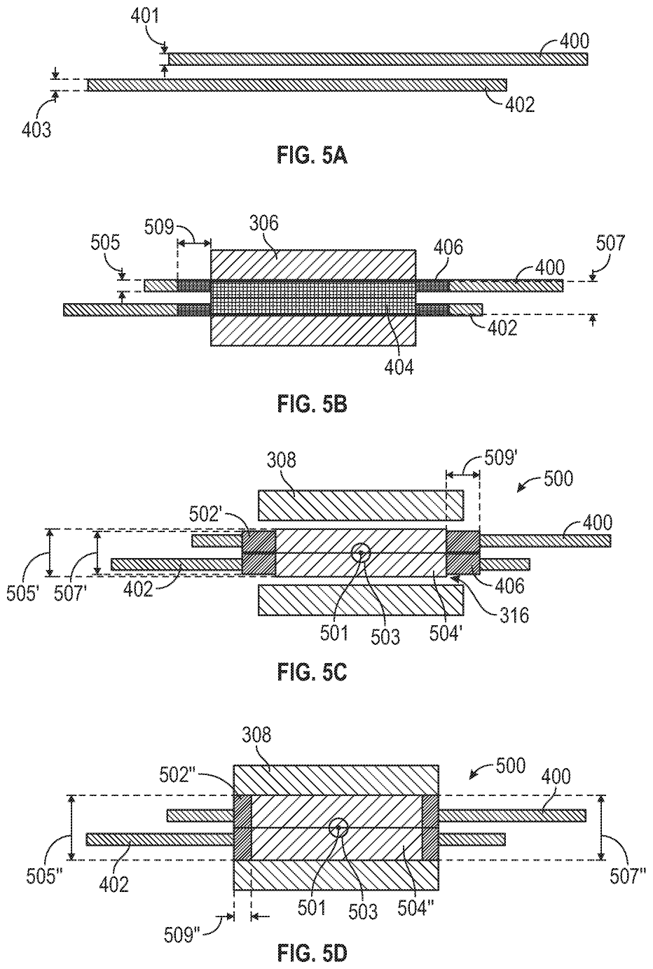

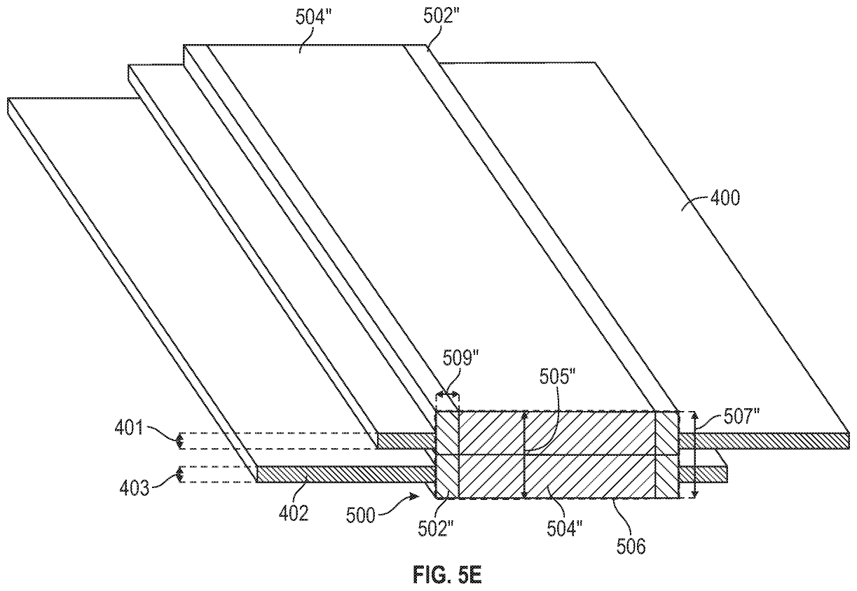

FIG. 2 further shows example stresses 200, 202 experienced at bond assemblies of a balloon with the balloon in an inflated configuration. In the inflated configuration a longitudinal stress 200 is applied to the bond assembly 118 along the gore edges 120 and is correspondingly aligned with the bond assembly 118. A transverse stress 202 is applied to the bond assembly 118 in a direction substantially transverse to the gore edges 120 and the bond assembly 118. In combination, the longitudinal stress 200 and the transverse stress 202 are an example biaxial stress applied to the bond assembly 118. In an example including fused bond assembly the stresses 200, 202, including biaxial stress, and component stresses (of the biaxial stress) preferentially damage or cause failure at the weakest component of the bond assembly. As described above, the fused portion of the bond assembly includes two or more bonded plies of the gore material while the proximate interface portions of the gore material interposed between the fused portion and the remainder of the gore material having directionally oriented molecules is has a lesser number of plies (e.g., a single ply) and is disoriented molecularly. This interface portion proximate to the bond fusion zone is thereby subject to damage and potentially failure due to the stresses whether alone or in combination. FIGS. 4B-D show one example of a bond assembly 408 having disoriented film interfaces 406. While FIGS. 5A-E show one example of a contracted bond assembly 500 including a bond fusion zone 404, 504′, 504″ and contracted film interface 502′, 502″ that provide enhanced strength to the assembly 500. For instance, the contracted bond assembly 500 including the bond fusion zone 504″ and contracted film interfaces 502″ provides enhanced strength approaching the strength (e.g., tensile strength) of the base material, such as a polymer having directionally oriented molecules.

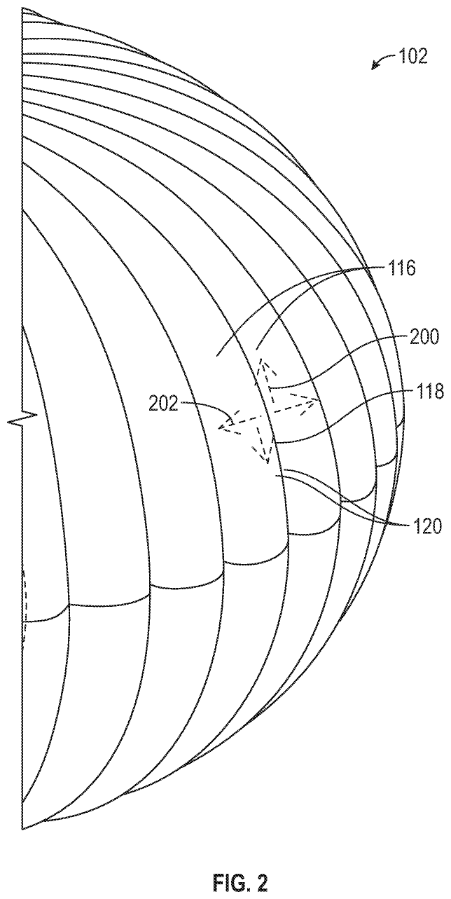

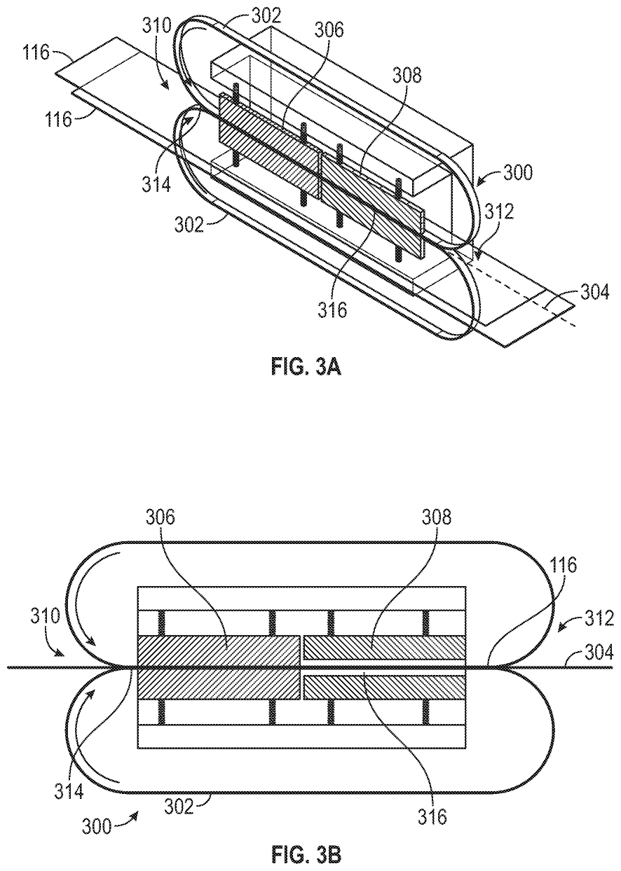

FIGS. 3A, B are schematic diagrams of one example of a bonding system 300 configured to bond material, such as gore material for balloons in balloon systems described herein. As shown in FIGS. 3A, B balloon gores 316, for instance films or sheets of polymer, are fed through the bonding system 300 and bonded with a bonding nip 314. A contracted bond assembly 304 as described herein is provided at a system outlet 312 of the bonding system 300. FIGS. 3A, B show one example of a bonding system 300 including a band sealer. In other examples the bonding system 300 includes, but is not limited to, a band sealer, impulse sealer or the like.

In this example, the bonding system 300 includes one or more bands 302 that are rotated through the system 300 with drives. The bands 302 engage with the balloon gores 116 at a system inlet 310 having the bonding nip 314. The bands 302 draw the gores 116 into the system 300. As shown in FIGS. 3A, B the system 300 includes one or more heating elements 306. The heating elements 306 heat one or both of the balloon gores 116 or the bands 302 engaged with the balloon gores 116 (in turn heating the gores). The heated balloon gores 116 are pressed together according to force applied with the bands 302 e.g., according to tolerances) and the combination of heat and pressure fuse the gores 116 together to form a bond fusion zone.

The fused balloon gores 116 continue through the bonding system 300 and are optionally received between cooling elements 308, including one or more of passively cooled (ambient temperature) or actively cooled (refrigerated) cooling plates. As shown in FIG. 3B the clearance or tolerance between the cooling elements 308 is greater than that of the heating elements 306. In the example shown, the clearance or tolerance is exaggerated for illustration purposes As shown in FIG. 3B a contraction nip 316 is between the cooling elements 308 and has a larger tolerance or clearance than the tolerance or clearance between the heating elements 306 having the bonding nip 314. Accordingly, the bands 302 apply less pressure to the balloon gores 116. As described herein, the relaxed contraction nip 316 (relative to the bonding nip 314) facilitates the contraction of the contracted bond assembly 304 and promotes coupling between the film interfaces of the bond assembly as well as thickening of the film interfaces and the bond fusion zone (collectively the contracted bond assembly). The bonded balloon gores 116 exit the example bonding system 300 at the system outlet 312 including a contracted bond assembly 304. One example of the contracted bond assembly 304 during and at the completion of assembly is shown in detail in FIGS. 5A-E.

In another example, and as described herein, a tensile force is applied to the balloon gores 116 at least while cooling (including during a portion of cooling), for instance between the cooling elements 308. Optionally, the tensile force is applied to the balloon gores 116 during bonding, for instance between the heating elements 306. The tensile force is applied with one or more of rollers, belts, clamps or the like that handle the balloon gores 116 for instance for feeding the gores 116 to the bonding system 300 and drawing the processed balloon gores 116 with the contracted bond assembly 304 from the bonding system 300. The components that draw the processed balloon gores 116 from the system 300 apply a greater force (tension) to the contracted bond assembly 304 proximate to the system outlet 312 than is applied at the system inlet 310. The imbalance of forces results intension applied to the balloon gores 116 and the contracted bond assembly 304.

A longitudinal bond axis of the contracted bond assembly 304 (the dashed line in FIG. 3A represents the axis and the assembly) are oriented along the tensile axis of the applied tensile force. The tensile force pulls the contracted bond assembly 304 and enhances contraction (narrowing) of the bond assembly, including the film interfaces and the fusion zone, toward the longitudinal bond axis. For instance, the tensile force promotes narrowing of the cooling bond assembly including the film interfaces and the fusion zone shown in FIGS. 5A-E toward the longitudinal bond axis and correspondingly enhances thickening of the film interfaces (and the fusion zone) and causes bonding between the film interfaces of the proximate balloon gores. The bonded film interfaces enhance the strength of the film interfaces (e.g., because of thickening and bonding) and in some examples provides film interfaces having tensile strength proximate to that of the bond fusion zone and the base material of the balloon gores 116 (for instance having directionally oriented molecules (and increased strength because of the directional orienting). In one example, the bond fusion zone includes a transverse bond strength and the contracted film interfaces include a transverse contracted strength (e.g., in directions transverse to the longitudinal bond axis) proximate to parent tensile strengths of the component balloon gores 116 having directionally oriented molecules. In another example, the bond fusion zone includes a biaxial bond strength and the contracted film interfaces include a biaxial contracted strength (e.g., in multiple directions including transverse and aligned with the longitudinal bond axis) proximate to parent tensile strengths of the component balloon gores 116 having directionally oriented molecules.

FIGS. 4A-D are cross sectional views of balloon gores (in this example first and second gore films 400, 402) assembled to provide an example bond assembly 408. In contrast FIGS. 5A-E illustrate the assembly of a contracted bond assembly 500 having contracted film interfaces (e.g., 502′ and 502″).

Referring first to FIG. 4A the first and second gore films 400, 402 are shown in a stacked configured, for instance prior to a bonding procedure. Each of the first and second films 400, 402 has respective first and second film thicknesses 401, 403. A stack thickness of the gore films 400, 402 corresponds to the composite of the film thicknesses of films (in this example first and second films) 401, 403. In FIG. 4B the first and second gore films 400, 402 are bonded at a bond fusion zone 404 with one or more heating elements 306 (shown in FIGS. 3A, B). The bands 302 are not shown in FIGS. 4B, C to minimize clutter in the views, but are shown in FIGS. 3A, B. The heating elements 306 (with or without intervening bands 302) apply pressure and heat to the first and second gore films 400, 402 and the gores bond (e.g., weld, adhere, merge or the like) to form the bond fusion zone 404.

As shown in FIG. 4B the portions of the films 400, 402 proximate to the bond fusion zone 404, the film interfaces 406, are heated with the heating elements 306 and are not bonded in an affirmative manner, for instance with pressure from the elements 306. As shown in FIG. 4C the cooling elements 308 (e.g., cooling plates) engage with the bond fusion zone 404 to cool the bond fusion zone 404 and similarly cool the film interfaces 406. The cooled bond assembly 408 sets the material of the bond fusion zone 404 and the film interfaces 406, for instance at the system outlet 312 shown in FIGS. 3A, B. The completed bond assembly 408 is shown in FIG. 4D. The bond fusion zone 404 interconnects the first and second films 400, 402. The film interfaces 406 associated with the first film 400 (on the right of the Figure) and the second film 402 (on the left) interconnect the bond fusion zone 404 to the remainder of the first and second films, and as described herein in one example include disoriented molecules that decrease mechanical characteristics of the assembly 408 at the interface.

In one example, the base material (e.g., a parent material) of at least one of the films of the bond assembly 408 includes directionally oriented molecules to enhance one or more mechanical characteristics of the gores and the inflatable article, such as the balloon 102 shown in FIG. 1. For instance, the directionally oriented molecules enhance one or more strengths including the tensile strength of the material, such as polyethylene. The heating of the film interfaces 406 disorients the otherwise directional oriented molecules (partially or entirely) and affects the mechanical characteristics, for instance decreasing the tensile strength of the base material. The bond fusion zone 404 shown in FIGS. 4B-D includes two or more bonded layers having a composite thickness that enhances the mechanical characteristics of the zone 404. In contrast, the film interfaces 406 are not affirmatively bonded, are not affirmatively thickened and also have disoriented molecules. In one example, these disoriented film interfaces 406 have one or more mechanical characteristics less than corresponding characteristics of the bond fusion zone 404 (having increased thickness) and the parent characteristics of the base material. For instance, a biaxial strength of the base material and biaxial strength of the bond fusion zone are greater than the biaxial strength of the disoriented film interfaces 406. In some examples, with one or more of transverse stress, biaxial stress (e.g., stresses along the axis of the bond assembly and transverse to the axis) or the like caused by inflation, operating conditions or the like the bond assembly 408 is damaged or fails along the disoriented film interfaces 406. Biaxial strength is a mechanical characteristic determined through testing (e.g., with burst cylinders) and is related to tensile strength for the parent material and bond strength with a bond assembly. Biaxial strength is conveyed in a similar manner to tensile strength but includes units of strength (e.g., psi, kPa or the like) per unit of axial length. In the context of bond assemblies and the parent material, the axial length is the transverse dimension of the parent material or bond assembly along the longitudinal axis of the bond assembly.

FIGS. 5A-E are one example of the assembly of a contract bond assembly 500. The contracted bond assembly includes one or more contracted film interfaces that enhance (e.g., increase) the otherwise decreased mechanical characteristics of a bond assembly, such as the bond assembly 408 shown in FIGS. 4B-D. In one example, the contracted bond assembly 500 is formed with a bonding system, such as the system 300 shown in FIGS. 3A, B. For example, the contracted bond assembly 500 assembled with one or more heating elements 306 configured to compress and heat component films, such as the first and second gore films 400, 402 (see FIG. 5A), and form a bond fusion zone 404. One example of the bond fusion zone 404 and the associated heating elements 306 is shown in a heated configuration in FIG. 5B.

As shown in FIG. 5B, in this heated configuration disoriented film interfaces 406 including disoriented molecules relative to the parent material of one or more of the gore films having oriented molecules are interposed between the bond fusion zone 404 and the remainder of the gore films 400, 402. The disoriented film interfaces 406 include interface widths 509 extending from the bond fusion zone 404 to the respective portions of the first and second gore films 400, 402. The remainder of the first and second gore films 400, 402 retain the oriented molecules (are not heated) and are not disoriented because of heating at the heating elements 306.

Referring now to FIG. 5C the contracted bond assembly 500 is shown between cooling elements 308 in a contracted configuration. In this example the cooling elements 308 include, but are not limited to, actively cooled (refrigerated) elements, passive cooling elements (e.g., ambient temperature) or air cooling (e.g., ambient temperature) elements that provide minimized contact and nipping of the assembly 500 (e.g., decreased relative to FIG. 4C or no contact with air cooling).

As shown in FIG. 5C the contraction nip 316 is included in this example to illustrate the passive engagement (tolerance) between the cooling elements 308 and the contracted bond assembly 500. The tolerance provided between the cooling elements 308 (including decreased or no engagement with the gore films 400, 402) facilitates the contraction of the bond assembly 500 and enhances one or more mechanical characteristics of the bond assembly 500. One example of the tolerance is shown with the contraction nip 316 in FIG. 5C. Although referred to as a nip, the contraction nip 316 in one example provides minimal or no contact between the bond assembly 500 and the cooling elements 308, and instead permits the bond assembly 500 to contract as discussed herein.

Referring again to FIG. 5C, the bond assembly 500 contracts relative to the assembly as shown in FIG. 5B. For instance, contacted film interfaces 502′ are shown that include interface widths 509′ that are less than the widths 509 shown in FIG. 5B. The bonding system 300, such as the cooling elements 308, permits the contraction of the bond assembly 500 prior to setting of the interfaces that would otherwise interrupt contraction. Accordingly, each of contacted film interfaces 502′ and the bond fusion zone 504′ contract inwardly (e.g., toward a tensile axis 501 where present aligned with a longitudinal bond axis 503 of the assembly 500 extending into and out of the page).

As shown in FIG. 5C as the bond assembly 500 contracts and one or more widths of the interfaces 406 narrow (decrease in width) one or more other dimensions of the bond assembly 500 are enhanced. A bond thickness 505′ of the bond fusion zone 504 increases as the bond assembly 500 contacts and fills the tolerance between the cooling elements 308 (or space provided during air cooling). Additionally, the interface thickness 507′ of the film interfaces 406 increases relative to the thickness shown in FIG. 5B (and relative to a stack thickness including both of the film thicknesses 401, 403 of the films 400, 402). The contracted (and thickened) film interfaces 502′ have enhanced mechanical characteristics (such as biaxial strength per unit length) relative to the film interfaces 406 shown in FIG. 5B (or FIGS. 4B-D). The film interfaces 502′ are affirmatively thickened by way of the contraction to provide enhanced structural integrity to film interfaces. As shown in FIG. 5B the contracted film interfaces 502′ each include respective thicknesses greater than the associated film thicknesses 401, 403. In some examples, the cooling and contraction of the contracted bond assembly 500 are controlled to modulate the thickening of the contracted film interfaces and control the associated mechanical characteristics of the interfaces.

As further shown in FIG. 5C the increased thickness facilitates the movement of the proximate interfaces 502′ toward each other. As shown in FIG. 5D with continued contraction the contracted interfaces 502′ bond and form contracted interfaces 502″ that are bonded and form a composite contracted interface 502″. In some examples, the bonding between the contracted interfaces 502″ further enhances the mechanical characteristics of the bond assembly 500, for instance through additive thickening of the composite interface when bonded. The previously separated interfaces 406 are bonded, and accordingly provide a composite structure (502″) that is, in some examples, stronger than the component (separated) interfaces 406, 502′. As previously described, disoriented molecules in the film interfaces 406 decrease the mechanical characteristics of the bond assembly 408 at the interfaces 406. With the contraction, thickening and optional bonding between the film interfaces 406 to form the contracted film interfaces 502′, 502″) mechanical characteristics of the interfaces are enhanced and optionally approach the characteristics of one or both of the bond fusion zone 504′ and the parent materials of the first or second gore films 400, 402.

As further shown in FIG. 5D, the contracted bond assembly 500 continues to contract and thicken to the configuration shown (e.g., another example of a contracted configuration). In one example, passive cooling provided by the cooling elements 308, air cooling or the like facilitates the gradual contraction and thickening of the contracted bond assembly 500 prior to setting of the materials (from a glass transition temperature or the like). The contracted bond assembly 500 thickens with the contracted film interfaces 502″ further narrowing and thickening into the configuration shown. In the example shown, the contracted film interfaces 502″ have interface thickness 507′ corresponding with the bond thickness 505″ of the bond fusion zone 504″. As shown the interface thickness 507″ in FIG. 5D is greater than the thickness 507′ in FIG. 5C as the interface 502″ narrows (laterally) and thickens (vertically). The contracted film interfaces 502″ in this example merge with the bond fusion zone 504″ and provide a contracted bond assembly 500 having consistent enhanced mechanical characteristics without outlier bond interfaces having decreased characteristics in other bond assemblies.

In the example including the cooling elements 308, as the bond assembly 500 contracts each of the bond fusion zone 504″ and the contracting film interfaces 502″ thicken at least until engaging the elements 308. Optionally, the cooling elements 308 support the bond assembly and guide (e.g., shape) the bond assembly to assume a profile corresponding to the contraction nip 316. For instance, the contraction nip 316 and the cooling elements 308 cooperate to engage with the bond assembly 500 and control the profile of the bond assembly, for instance as shown in FIGS. 5D and 5E (having the cooling elements 308 removed). FIG. 5E shows one example of a specified bond profile 506 (shown in broken lines) of the contracted bond assembly 500 with each of the bond fusion zone 504″ and the contracted film interfaces 502″ having profiles that correspond with the tolerance or contract nip 316 of the cooling elements 308. One example of a specified bond profile 506 is shown in FIG. 5E including a planar profile. In other examples the specified bond profile 506 includes other profiles such as, but not limited to, a contoured profile, stepped profile, sloped profile, rounded profile or the like, for instance based on a complementary profile of the cooling elements 308 that shape the contracted bond assembly 500.

Passively cooling the bond assembly 500 facilitates the contraction of the bond assembly including at least the film interfaces 406 to form the contracted film interfaces 502′, 502″. For example, passively cooling allows the heated material of the contracted bond assembly 500 to gradually contract and remain above a glass transition temperature or the like to facilitate thickening and bonding of the film interfaces into the contracted (and thickened) film interfaces 502′, 502″ that provide enhanced mechanical characteristics to the assembly 500 and minimize (e.g., decrease or eliminate) damage or failure along the interfaces. Active cooling (e.g., with refrigerants or the like) that promotes rapid cooling and setting of bond assemblies, such as the assembly 408 shown in FIG. 4D in some examples minimizes the potential for contraction of the bond assembly and accordingly the film interfaces 406 remain separated and have decreased mechanical characteristics. In other examples, active cooling is used with the contracted bond assembly 500. Active cooling in this example is controlled (e.g., for instance at temperatures that gradually cool the bond assembly and permit contraction and thickening). For instance, in one example actively cooled elements 308 are maintained at a temperature below 10, 20, 30 degrees Celsius or the like of the material glass transition temperature to provided controlled cooling while at the same time slowing setting of the film materials to facilitate contraction and thickening.

As discussed herein, in another example tensile forces are optionally applied to the bond assembly 500 to assist with contraction. An example tensile axis 501 is shown in FIGS. 5C and 5D that is aligned with a longitudinal bond axis of the bond assembly 500 (both extending into and out of the page). In the example contracted bond assembly 500 the tensile axis 501 is shown in FIG. 5B and FIG. 5C (e.g., cooling). In another example, and as discussed herein, application of tensile force is optionally conducted during one or more portions of the bonding process including during bonding (e.g., FIG. 5A) instead of or in addition to cooling and shaping of the bond assembly (e.g., FIGS. 5B, C). The applied tensile force guides (e.g., promotes, prompts or the like) contraction of the bond assembly 500. For instance, the bond assembly including one or more of the film interfaces 406 and the bond fusion zone 504′, 504″ contract transversely relative to the tensile force (e.g., toward the tensile axis 501). The promotion of inward contraction correspondingly promotes thickening of one or both of the bond fusion zone 504′, 504″ and the film interfaces 406 and promotes thickening of the interfaces to form the contracted film interfaces 502′, 502″ and enhance the mechanical characteristics of the contracted bond assembly 500. Tensile forces are optionally applied through one or more rolling assemblies, clamps or the like that apply a controlled tensile force to the films 400, 402 to promote contraction and thickening.

FIG. 5E is a perspective view of the contracted bond assembly 500. As shown the contracted film interfaces 502″ having the interface widths 509″ include the previous film interfaces 406 thickened and bonded together to enhance the mechanical characteristics of the contracted film interfaces 502″ relative to the previous component film interfaces 406. In this example, the interface thickness 507″ of the contracted film interfaces 502″ matches the bond thickness 505″ of the bond fusion zone 504″. In other examples the contracted film interfaces 502″ may include a different thickness than the bond fusion zone 504″ while providing a bond between the component bond interfaces 406 that forms the contracted film interfaces 502″. For example, the contracted film interfaces 502″ include interface thicknesses that are equal to or greater than a stack thickness corresponding to a sum of the first and second film thicknesses 401, 403.

The contracted bond assembly 500 including at least one of the example bond fusion zones 504′, 504″ and associated contracted interfaces 502′, 502″ includes enhanced mechanical characteristics relative to other bond assemblies, such as the bond assembly 408 shown in FIGS. 4B-D. For example, each of the first and second polymer films have respective first and second parent strengths based on orientation of molecules, such as biaxial strengths per unit of axial length associated with a tensile strength of the material. In one example, the bond fusion zones 504′, 504″ include a biaxial bond strengths proximate to the first and second parent strengths. For instance, the biaxial bond strength of the zones 504′, 504″ is at least 100 percent or more of the corresponding biaxial strength of the parent materials. In other examples the biaxial bond strength is 110, 120, 125 percent or more of the biaxial strength of the parent materials. As described herein the contraction and corresponding thickening of one or more of the contracted interfaces 502′, 502″ and the bond fusion zones 504′, 504″ enhance the mechanical characteristics of the bond assembly including the disoriented (molecularly) interfaces 406. In other examples, the contraction enhances the mechanical characteristics of the bond assembly for instance along bond surfaces between the fusion zones 504′, 504″ and the interfaces 502′, 502″. The fusion of the materials along these surfaces during bonding provides a molecular bond therebetween. Contraction strengthens this bond. For instance, contraction of the bond assembly 500 compresses and interlocks the molecular bonds (e.g., like compressed interlocking fingers) increases the mechanical characteristics of the bond assembly 500. In one example, delamination, peeling or the like between the films at the bond assembly 500 is minimized (e.g., decreased or eliminated) relative to other bond assemblies, such as the bond assembly 408.

In another example, the contracted film interfaces 502′, 502″ include biaxial interface strengths proximate to the first and second parent strengths of the first and second films 400, 402. For instance, the biaxial interface strengths of the interfaces 502′, 502″ is at least 80 percent or more of the corresponding biaxial strength of the parent materials. In other examples the biaxial bond strength is 85, 90, 95 or 100 percent or more of the biaxial strength of the parent materials.

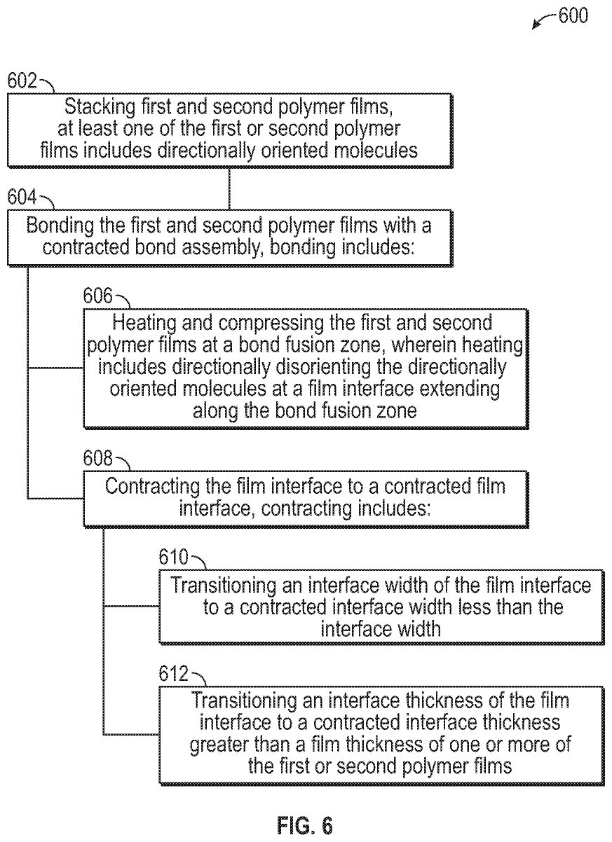

FIG. 6 shows one example of a method 600 for bonding films, for instance as part of a balloon system including an inflatable article (e.g., a balloon, dirigible, air ship, aerostat or the like). In describing the method 600 reference is made to one or more components, features, functions, steps or the like described herein. Where convenient reference is made to the components, features, functions, steps or the like with reference numerals. Reference numerals provided are exemplary and are not exclusive. For instance, the features, components, functions, steps and the like described in the method 600 include, but are not limited to, the corresponding numbered elements, other corresponding features described herein, both numbered and unnumbered as well as their equivalents.

At 602, the method 600 includes stacking first and second polymer films 400, 402, such as gores of an inflatable article. In other examples, the method 600 includes stacking two or more films. Optionally, one or more of the first or second films 400, 402 include directionally oriented molecules (e.g., to provide enhanced characteristics, such as tensile strength or biaxial strength per unit of axial length). Each of the films includes respective film thicknesses 401, 403, and having a stack thickness corresponding to the summed film thicknesses when stacked.

At 604 the first and second polymer films 400, 402 are bonded with a contracted bond assembly 500. At 606 bonding includes heating and compressing the first and second polymer films 400, 402 at a bond fusion zone 404. Heating directionally disorients the directionally oriented molecules at one or more film interfaces 406 extending along the bond fusion zone 404. For instance the film interfaces 406 extend along the edges of the bond fusion zone 404 and provide the interface between the zone 404 and the remainder of the polymer films 400, 402. In one example, the remainder of the polymer films are not sufficiently heated to disorient the molecules and accordingly maintain the directionally oriented molecules that enhance the mechanical characteristics of one or more of the films.

Bonding (606) includes at 608 contracting the one or more film interfaces 406 to contracted film interfaces 502′, 502″. Contracting the one or more film interfaces includes at 610 transitioning an interface width 509 of the film interface 406 to a contracted interface width 509′ (and optionally 509″) less than the interface width 509. At 612 contracting includes transitioning an interface thickness 505 of the film interface 406 to a contracted thickness 505′ (and option 505″) of the contracted film interface 502′ (or 502″) greater than the stack thickness of the films 400, 402. As described herein contraction of the film interfaces in one example bonds proximate film interfaces together, increases the thickness of the contracted film interfaces 502′ (or 502″) and provides enhanced mechanical characteristics to the contracted bond assembly 500 that minimize damage or failure at the bond assembly (e.g., along the film interfaces having disoriented molecules). The bonded interfaces 502′ (or 502″) instead reinforce the otherwise separated film interfaces 406 and enhance the bond assembly 500 mechanical characteristics.

Several options for the method 600 follow. In one example heating and compressing the first and second polymer films 400, 402 is conducted at a first compression force and a first tolerance, for instance provided with a bonding nip 314 (see FIGS. 3A, B). Contracting the film interface to the contracted film interface 502′ is conducted at one or more of a second compression force less than the first compression force or a second tolerance greater than the first tolerance, for instance with a contraction nip 316 having increased tolerance or gap between cooling elements and accordingly applying less compression force (including no compression force in an example). In another example, contracting the film interface 406 to the contracted film interface 502′ (or 502″) includes tensioning the bond fusion zone along a tensile axis 501 (see FIGS. 5C, D). For instance, contracting the film interface 406 to the contracted film interface 502′ or 502″ includes contracting the film interface toward the tensile axis 501. Optionally, bonding the first and second polymer films with the contracted bond assembly 500 includes contracting the bond fusion zone 404 toward the tensile axis 501 and transitioning a bond thickness 507 (FIG. 5B) of the bond fusion zone 404 to a contracted bond thickness 507′ (or 507″) greater than the stack thickness of the films 400, 402.

In another example, contracting the film interface 406 is maintained after heating and compressing (606) of the first and second polymer films 400, 402. In still another example, contracting the film interface 406 is maintained during heating and compressing (606) of the first and second polymer films 400, 402. In these examples a tensile force is applied along the tensile axis to promote contraction.

The method 600 includes in another example passively cooling the film interface 502′ (or 502″) to ambient temperature. For instance, one or more of cooling elements 308 that are not actively cooled are positioned along the bond assembly 500 to gradually cool the bond assembly and permit contraction (e.g., before the film interfaces and bond fusion zone drop below a glass transition temperature or set). In one example, passively cooling the film interface 502′ (or 502″) to ambient temperature includes air cooling the film interface.

Tables 1-3 provided herein illustrate mechanical characteristics, failure modes or the like of a bond assembly 408 as shown in FIG. 4B-D and comparative mechanical characteristics, failure modes or the like of a contracted bond assembly 500 as shown in FIGS. 5C-E and described here. The base materials of the component films 400, 402 of each of the assemblies 408, 500 include polyethylene having directionally oriented molecules. Table 1 provides a comparison of each of the bond assembly 408 (“Previous Bond Assembly”) and the contracted bond assembly 500 by way of a uniaxial tensile test conducted on populations of 20 samples of each of the assemblies 408, 500.

TABLE 1
Strength Comparison (n = 20)

Uniaxial Testing

| | Previous Bond | Contracted Bond |
|---|---|---|
| | Assembly | Assembly |
| Average | 70.89 N | 82.63 N |
| Standard Deviation | 3.09 N | 2.73 N |
| −3σ | 61.62 N | 74.44 N |
| Average @ −40 C. | 108.02 N | 148.03 N |

As shown the bond assembly 408 including film interfaces 406 (see FIGS. 4C, D) was tested and indicated a tensile force of around 70.89 Newtons (N) before failure. In comparison, the contracted bond assembly 500 when assessed with the same test indicated a tensile force of 82.63 N before failure, a difference of approximately 12 N. Further, when tested at an operating temperature of −40 degrees Celsius similar to an actual operating temperature (e.g., stratospheric, high altitude operation or the like) the tensile force of the contracted bond assembly 500 before failure was 148.03 N while the bond assembly 408 had a tensile force before failure of 108.02 N indicating the contracted bond assembly 500 was significantly stronger than the bond assembly 408 at lower (operating) temperatures.

Table 2 includes cylinder burst test results for ten samples of a bond assembly 408 (as shown in FIGS. 4B-D). The results of the testing include burst pressures in units of pounds per square inch (psi) and kilopascals (kPa). Additionally, Table 2 includes a description of the failure mode for each of the bond assemblies 408.

TABLE 2
Cylinder Burst Test with Previous Bond Assemblies

| Cylinder | Burst Pressure | Burst Pressure | |
|---|---|---|---|
| Number | (psi) | (kPa) | Failure Mode |
| 1 | 9.21 | 63.5 | Film Interface |
| 2 | 8.74 | 60.3 | Film Interface |
| 3 | 8.74 | 60.3 | Film Interface |
| 4 | 8.67 | 59.8 | Film Interface |
| 5 | 8.85 | 61.0 | Film Interface |
| 6 | 8.50 | 58.6 | Film Interface |
| 7 | 9.50 | 65.5 | Film Interface |
| 8 | 9.28 | 63.9 | Film Interface |
| 9 | 9.53 | 65.7 | Film Interface |
| 10 | 8.13 | 56.0 | Film Interface |

As shown, each of the bond assemblies 408 failed along the film interfaces corresponding to the film interfaces 406 shown in FIGS. 4B-D. As previously described the film interfaces 406 include disoriented molecules relative to the remainder of the films 400, 402 constructed with the parent material (having oriented molecules) because of heating as the bond fusion zone 404 (FIGS. 4B-D) is formed.

Table 3 includes cylinder burst test results for samples of the contracted bond assembly 500. As shown, the burst pressures for the sample contracted bond assemblies 500 are higher relative to the corresponding bond assemblies 408 shown in Table 2.

TABLE 3
Cylinder Burst Test with Contracted Bond Assemblies

| Cylinder | Burst Pressure | Burst Pressure | |
|---|---|---|---|
| Number | (psi) | (kPa) | Failure Mode |
| 1 | 10.6 | 73.1 | Parent Material |
| 2 | 10.88 | 75.0 | Parent Material |
| 3 | 10.04 | 69.2 | Parent Material |
| 4 | 10.54 | 72.7 | Parent Material |
| 5 | 10.56 | 72.8 | Parent Material |
| 6 | 10.17 | 70.1 | Parent Material |
| 7 | 10.76 | 74.2 | Parent Material |

In some examples the difference between the average burst pressures of the bond assemblies 408, 61.46 kPa and those of the contracted bond assemblies 500, 72.4 kPa is approximate 11 kPa in favor of the contracted bond assemblies 500. Further, the failure mode of the contracted bond assemblies 500 is in the parent material of the films 400, 402 and not in a component of the contracted bond assemblies 500 (e.g., having the contracted film interfaces 502′, 502″ and bond fusion zones 504′, 504″). Accordingly, the contracted bond assemblies 500 provide a strengthened connection between gore films of inflatable articles that are resistant to failure and thereby enhance the overall durability and operational lifespan of inflatable articles using the bond assemblies 500.

### VARIOUS NOTES AND EXAMPLES

Aspect 1 can include subject matter such as a polymer film assembly comprising: a stack of two or more polymer films, and at least one of the polymer films includes directionally oriented molecules, the stack includes: a first polymer film having a first film thickness; and a second polymer film having a second film thickness layered with the first polymer film, the second polymer film having directionally oriented molecules; and a contracted bond assembly couples at least the first and second polymer films of the stack, the contracted bond assembly includes heated and contracted configurations: in the heated configuration the contracted bond assembly includes a bond fusion zone and a film interface having directionally disoriented molecules and an interface width between the bond fusion zone and the remainder of the first and second polymer films; and in the contracted configuration the film interface is a contracted film interface having a contracted interface width less than the interface width and a contracted thickness greater than one or more of the first or second film thicknesses.

Aspect 2 can include, or can optionally be combined with the subject matter of Aspect 1, to optionally include wherein the first polymer film is a first balloon gore, and the second polymer film is a second balloon gore.

Aspect 3 can include, or can optionally be combined with the subject matter of one or any combination of Aspects 1 or 2 to optionally include wherein the bond fusion zone includes a bond thickness greater than a stack thickness of the first and second film thicknesses.

Aspect 4 can include, or can optionally be combined with the subject matter of one or any combination of Aspects 1-3 to optionally include wherein the bond thickness corresponds with the contracted thickness.

Aspect 5 can include, or can optionally be combined with the subject matter of one or any combination of Aspects 1-4 to optionally include wherein the contracted bond assembly includes a specified bond profile including a planar profile extending from the bond fusion zone into the contracted film interface.

Aspect 6 can include, or can optionally be combined with the subject matter of Aspects 1-5 to optionally include wherein bond fusion zone includes a longitudinal bond axis, and the contracted film interface is contracted toward the longitudinal bond axis in the contracted configuration relative to the heated configuration.

Aspect 7 can include, or can optionally be combined with the subject matter of Aspects 1-6 to optionally include wherein the contracted bond assembly includes a tensile axis, and the longitudinal bond axis and the contracted film interface are oriented along the tensile axis.

Aspect 8 can include, or can optionally be combined with the subject matter of Aspects 1-7 to optionally include wherein in the contracted configuration the contracted bond assembly is in tension along a tensile axis, and the contracted film interface is narrowed from the interface width toward the contracted interface width transversely relative to the tensile axis.

Aspect 9 can include, or can optionally be combined with the subject matter of Aspects 1-8 to optionally include wherein each of the first and second polymer films have respective first and second parent strengths, and: the bond fusion zone includes a biaxial bond strength proximate to the first and second parent strengths of the first and second polymer films; and the contracted film interface includes a biaxial interface strength proximate to the first and second parent strengths of the first and second polymer films.

Aspect 10 can include, or can optionally be combined with the subject matter of Aspects 1-9 to optionally include wherein the biaxial interface strength is a strength per unit of axial length and the first and second parent strengths are respective first and second strengths per unit of axial length; and the biaxial interface strength is at least 80 percent as strong as the first or second parent strength.

Aspect 11 can include, or can optionally be combined with the subject matter of Aspects 1-10 to optionally include wherein the biaxial bond strength is a strength per unit of axial length and the first and second parent strengths are respective first and second strengths per unit of axial length; and the biaxial bond strength is at least 100 percent as strong as the first or second parent strength.

Aspect 12 can include, or can optionally be combined with the subject matter of Aspects 1-11 to optionally include wherein the film interface in the heated configuration includes a first film interface of the first polymer film and a second film interface of the second polymer film separated from the first film interface; and in the contracted configuration the first and second film interfaces are bonded together.

Aspect 13 can include, or can optionally be combined with the subject matter of Aspects 1-12 to optionally include wherein the film interface in the heated configuration includes a first film interface of the first polymer film and a second film interface of the second polymer film; and in the contracted configuration the first and second film interfaces are separated with the contracted thickness greater than the respective first and second film thicknesses.

Aspect 14 can include, or can optionally be combined with the subject matter of Aspects 1-13 to optionally include a balloon assembly having a plurality of the polymer films, a plurality of the stacks of two or more of the polymer films and a plurality of the contracted bond assemblies as seams of the balloon assembly.

Aspect 15 can include, or can optionally be combined with the subject matter of Aspects 1-14 to optionally include a polymer film assembly comprising: a stack of two or more polymer films, and at least one of the polymer films includes directionally oriented molecules, the stack includes: a first polymer film having a first film thickness; and a second polymer film having a second film thickness layered with the first polymer film, the second polymer film having directionally oriented molecules; and a contracted bond assembly couples at least the first and second polymer films of the stack, the contracted bond assembly includes: a bond fusion zone; a contracted film interface interposed between the bond fusion zone and the remainder of at least one of the first and second polymer films; and wherein the contracted film interface includes portions of the first and second polymer films having directionally disoriented molecules, and the contracted film interface has a contracted thickness greater than one or more of the first or second film thicknesses.

Aspect 16 can include, or can optionally be combined with the subject matter of Aspects 1-15 to optionally include wherein the first polymer film includes directionally oriented molecules.

Aspect 17 can include, or can optionally be combined with the subject matter of Aspects 1-16 to optionally include wherein the bond fusion zone includes a bond thickness greater than a stack thickness of the first and second film thicknesses.

Aspect 18 can include, or can optionally be combined with the subject matter of Aspects 1-17 to optionally include wherein the bond thickness corresponds with the contracted thickness.

Aspect 19 can include, or can optionally be combined with the subject matter of Aspects 1-18 to optionally include wherein the contracted bond assembly includes a specified bond profile including a planar profile extending from the bond fusion zone into the contracted film interface.

Aspect 20 can include, or can optionally be combined with the subject matter of Aspects 1-19 to optionally include wherein bond fusion zone includes a longitudinal bond axis, and the contracted film interface is contracted toward the longitudinal bond axis.

Aspect 21 can include, or can optionally be combined with the subject matter of Aspects 1-20 to optionally include wherein the contracted bond assembly includes a tensile axis, and the longitudinal bond axis and the contracted film interface are oriented along the tensile axis.

Aspect 22 can include, or can optionally be combined with the subject matter of Aspects 1-21 to optionally include wherein the contracted film interface includes first and second contracted film interfaces, and the bond fusion zone is interposed between the first and second contracted film interfaces.

Aspect 23 can include, or can optionally be combined with the subject matter of Aspects 1-22 to optionally include wherein the bond fusion zone includes longitudinal bond axis, and the first and second contracted film interfaces extend along the longitudinal body axis.

Aspect 24 can include, or can optionally be combined with the subject matter of Aspects 1-23 to optionally include wherein each of the first and second polymer films have respective first and second parent strengths, and: the bond fusion zone includes a biaxial bond strength proximate to the first and second parent strengths of the first and second polymer films; and the contracted film interface includes a biaxial interface strength proximate to the first and second parent strengths of the first and second polymer films.

Aspect 25 can include, or can optionally be combined with the subject matter of Aspects 1-24 to optionally include wherein the biaxial interface strength is a strength per unit of axial length and the first and second parent strengths are respective first and second strengths per unit of axial length; and the biaxial interface strength is at least 85 percent as strong as the first or second parent strength.

Aspect 26 can include, or can optionally be combined with the subject matter of Aspects 1-25 to optionally include wherein the biaxial bond strength is a strength per unit of axial length and the first and second parent strengths are respective first and second strengths per unit of axial length; and the biaxial bond strength is at least 125 percent as strong as the first or second parent strength.

Aspect 27 can include, or can optionally be combined with the subject matter of Aspects 1-26 to optionally include wherein the contracted film interface includes a first film interface of the first polymer film and a second film interface of the second polymer film bonded together.

Aspect 28 can include, or can optionally be combined with the subject matter of Aspects 1-27 to optionally include wherein the contracted film interface includes a first film interface of the first polymer film and a second film interface of the second polymer film separated from each other.

Aspect 29 can include, or can optionally be combined with the subject matter of Aspects 1-28 to optionally include a balloon assembly having a plurality of the polymer films, a plurality of the stacks of two or more of the polymer films and a plurality of the contracted bond assemblies as seams of the balloon assembly.

Aspect 30 can include, or can optionally be combined with the subject matter of Aspects 1-29 to optionally include a method for bonding polymer films comprising: stacking first and second polymer films, at least one of the first or 25 second polymer films includes directionally oriented molecules; and bonding the first and second polymer films with a contracted bond assembly, bonding includes: heating and compressing the first and second polymer films at a bond fusion zone, wherein heating includes directionally disorienting the directionally oriented molecules at a film interface extending along the bond fusion zone; and contracting the film interface to a contracted film interface, contracting includes: transitioning an interface width of the film interface to a contracted interface width less than the interface width; and transitioning an interface thickness of the film interface to a contracted interface thickness greater than a film thickness of one or more of the first or second polymer films.

Aspect 31 can include, or can optionally be combined with the subject matter of Aspects 1-30 to optionally include wherein the film interface includes first and second film interfaces of the respective first and second polymer films; and contracting the film interface to the contracted film interface includes bonding the first and second film interfaces together.

Aspect 32 can include, or can optionally be combined with the subject matter of Aspects 1-31 to optionally include wherein heating and compressing the first and second polymer films is conducted at a first compression force and a first tolerance; and wherein contracting the film interface to the contracted film interface is conducted at one or more of a second compression force less than the first compression force or a second tolerance greater than the first tolerance.

Aspect 33 can include, or can optionally be combined with the subject matter of Aspects 1-32 to optionally include wherein contracting the film interface to the contracted film interface includes tensioning the bond fusion zone along a tensile axis.

Aspect 34 can include, or can optionally be combined with the subject matter of Aspects 1-33 to optionally include wherein contracting the film interface to the contracted film interface includes contracting the film interface toward the tensile axis.

Aspect 35 can include, or can optionally be combined with the subject matter of Aspects 1-34 to optionally include wherein bonding the first and second polymer films with the contracted bond assembly includes contracting the bond fusion zone toward the tensile axis and transitioning a bond thickness of the bond fusion zone to a contracted bond thickness greater than an initial bond thickness.

Aspect 36 can include, or can optionally be combined with the subject matter of Aspects 1-35 to optionally include wherein contracting the film interface is conducted after heating and compressing of the first and second polymer films.

Aspect 37 can include, or can optionally be combined with the subject matter of Aspects 1-36 to optionally include passively cooling the film interface to ambient temperature.

Aspect 38 can include, or can optionally be combined with the subject matter of Aspects 1-37 to optionally include wherein passively cooling the film interface to ambient temperature includes air cooling the film interface.

Each of these non-limiting aspects can stand on its own, or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A polymer film assembly comprising:
a stack of two or more polymer films, and at least one of the polymer films includes directionally oriented molecules, the stack includes:
a first polymer film having a first film thickness; and
a second polymer film having a second film thickness layered with the first polymer film, the second polymer film having directionally oriented molecules; and
a contracted bond assembly couples at least the first and second polymer films of the stack, the contracted bond assembly includes heated and contracted configurations:
in the heated configuration the contracted bond assembly includes a bond fusion zone and a film interface having directionally disoriented molecules and an interface width between the bond fusion zone and the remainder of the first and second polymer films; and
in the contracted configuration the film interface is a contracted film interface having a contracted interface width less than the interface width and a contracted thickness greater than one or more of the first or second film thicknesses.

2. The polymer film assembly of claim 1, wherein the first polymer film is a first balloon gore, and the second polymer film is a second balloon gore.

3. The polymer film assembly of claim 1, wherein the bond fusion zone includes a bond thickness greater than a stack thickness of the first and second film thicknesses.

4. The polymer film assembly of claim 3, wherein the bond thickness corresponds with the contracted thickness.

5. The polymer film assembly of claim 1, wherein the contracted bond assembly includes a specified bond profile including a planar profile extending from the bond fusion zone into the contracted film interface.

6. The polymer film assembly of claim 1, wherein the bond fusion zone includes a longitudinal bond axis, and the contracted film interface is contracted toward the longitudinal bond axis in the contracted configuration relative to the heated configuration.

7. The polymer film assembly of claim 6, wherein the contracted bond assembly includes a tensile axis, and the longitudinal bond axis and the contracted film interface are oriented along the tensile axis.

8. The polymer film assembly of claim 1, wherein in the contracted configuration the contracted bond assembly is in tension along a tensile axis, and the contracted film interface is narrowed from the interface width toward the contracted interface width transversely relative to the tensile axis.

9. The polymer film assembly of claim 1, wherein each of the first and second polymer films have respective first and second parent strengths, and:
the bond fusion zone includes a biaxial bond strength proximate to the first and second parent strengths of the first and second polymer films; and
the contracted film interface includes a biaxial interface strength proximate to the first and second parent strengths of the first and second polymer films.

10. The polymer film assembly of claim 9, wherein the biaxial interface strength is a strength per unit of axial length and the first and second parent strengths are respective first and second strengths per unit of axial length; and
the biaxial interface strength is at least 80 percent as strong as the first or second parent strength.

11. The polymer film assembly of claim 9, wherein the biaxial bond strength is a strength per unit of axial length and the first and second parent strengths are respective first and second strengths per unit of axial length; and
the biaxial bond strength is at least 100 percent as strong as the first or second parent strength.

12. The polymer film assembly of claim 1, wherein the film interface in the heated configuration includes a first film interface of the first polymer film and a second film interface of the second polymer film separated from the first film interface; and
in the contracted configuration the first and second film interfaces are bonded together.

13. The polymer film assembly of claim 1, wherein the film interface in the heated configuration includes a first film interface of the first polymer film and a second film interface of the second polymer film; and
in the contracted configuration the first and second film interfaces are separated with the contracted thickness greater than the respective first and second film thicknesses.

14. The polymer film assembly of claim 1 comprising a balloon assembly having a plurality of the polymer films, a plurality of the stacks of two or more of the polymer films and a plurality of the contracted bond assemblies as seams of the balloon assembly.

15. A polymer film assembly comprising:
a stack of two or more polymer films, and at least one of the polymer films includes directionally oriented molecules, the stack includes:
a first polymer film having a first film thickness; and
a second polymer film having a second film thickness layered with the first polymer film, the second polymer film having directionally oriented molecules; and
a contracted bond assembly couples at least the first and second polymer films of the stack, the contracted bond assembly includes:
a bond fusion zone;
a contracted film interface interposed between the bond fusion zone and the remainder of at least one of the first and second polymer films; and
wherein the contracted film interface includes portions of the first and second polymer films having directionally disoriented molecules, and the contracted film interface has a contracted thickness greater than one or more of the first or second film thicknesses.

16. The polymer film assembly of claim 15, wherein the first polymer film includes directionally oriented molecules.

17. The polymer film assembly of claim 15, wherein the bond fusion zone includes a bond thickness greater than a stack thickness of the first and second film thicknesses.

18. The polymer film assembly of claim 17, wherein the bond thickness corresponds with the contracted thickness.

19. The polymer film assembly of claim 15, wherein the contracted bond assembly includes a specified bond profile including a planar profile extending from the bond fusion zone into the contracted film interface.

20. The polymer film assembly of claim 15, wherein bond fusion zone includes a longitudinal bond axis, and the contracted film interface is contracted toward the longitudinal bond axis.

21. The polymer film assembly of claim 20, wherein the contracted bond assembly includes a tensile axis, and the longitudinal bond axis and the contracted film interface are oriented along the tensile axis.

22. The polymer film assembly of claim 15, wherein the contracted film interface includes first and second contracted film interfaces, and the bond fusion zone is interposed between the first and second contracted film interfaces.

23. The polymer film assembly of claim 22, wherein the bond fusion zone includes longitudinal bond axis, and the first and second contracted film interfaces extend along the longitudinal body axis.

24. The polymer film assembly of claim 15, wherein each of the first and second polymer films have respective first and second parent strengths, and:
the bond fusion zone includes a biaxial bond strength proximate to the first and second parent strengths of the first and second polymer films; and
the contracted film interface includes a biaxial interface strength proximate to the first and second parent strengths of the first and second polymer films.

25. The polymer film assembly of claim 24, wherein the biaxial interface strength is a strength per unit of axial length and the first and second parent strengths are respective first and second strengths per unit of axial length; and
the biaxial interface strength is at least 85 percent as strong as the first or second parent strength.

26. The polymer film assembly of claim 24, wherein the biaxial bond strength is a strength per unit of axial length and the first and second parent strengths are respective first and second strengths per unit of axial length; and
the biaxial bond strength is at least 125 percent as strong as the first or second parent strength.

27. The polymer film assembly of claim 15, wherein the contracted film interface includes a first film interface of the first polymer film and a second film interface of the second polymer film bonded together.

28. The polymer film assembly of claim 15, wherein the contracted film interface includes a first film interface of the first polymer film and a second film interface of the second polymer film separated from each other.

29. The polymer film assembly of claim 15 comprising a balloon assembly having a plurality of the polymer films, a plurality of the stacks of two or more of the polymer films and a plurality of the contracted bond assemblies as seams of the balloon assembly.

30. A method for bonding polymer films comprising:
stacking first and second polymer films, at least one of the first or second polymer films includes directionally oriented molecules; and
bonding the first and second polymer films with a contracted bond assembly, bonding includes:
heating and compressing the first and second polymer films at a bond fusion zone, wherein heating includes directionally disorienting the directionally oriented molecules at a film interface extending along the bond fusion zone; and
contracting the film interface to a contracted film interface, contracting includes:
transitioning an interface width of the film interface to a contracted interface width less than the interface width; and
transitioning an interface thickness of the film interface to a contracted interface thickness greater than a film thickness of one or more of the first or second polymer films.

31. The method of claim 30, wherein the film interface includes first and second film interfaces of the respective first and second polymer films; and
contracting the film interface to the contracted film interface includes bonding the first and second film interfaces together.

32. The method of claim 30, wherein heating and compressing the first and second polymer films is conducted at a first compression force and a first tolerance; and
wherein contracting the film interface to the contracted film interface is conducted at one or more of a second compression force less than the first compression force or a second tolerance greater than the first tolerance.

33. The method of claim 30, wherein contracting the film interface to the contracted film interface includes tensioning the bond fusion zone along a tensile axis.

34. The method of claim 33, wherein contracting the film interface to the contracted film interface includes contracting the film interface toward the tensile axis.

35. The method of claim 33, wherein bonding the first and second polymer films with the contracted bond assembly includes contracting the bond fusion zone toward the tensile axis and transitioning a bond thickness of the bond fusion zone to a contracted bond thickness greater than an initial bond thickness.

36. The method of claim 30, wherein contracting the film interface is conducted after heating and compressing of the first and second polymer films.

37. The method of claim 30 comprising passively cooling the film interface to ambient temperature.

38. The method of claim 37, wherein passively cooling the film interface to ambient temperature includes air cooling the film interface.
